(19) United States
(12) Patent Application Publication
(10) Pub. No.: US 2025/0382140 A1
(43) Pub. Date: Dec. 18, 2025

(54) SYSTEMS, METHODS, AND COMPONENTS FOR PACKAGE HANDLING AND SORTATION INCLUDING CONTAINER EXCHANGE PROCESS

(71) Applicant: Aegis Sortation, LLC, Louisville, KY (US)

(72) Inventors: Dean TERRELL, Louisville, KY (US); Jeffrey Paul HENLEY, Louisville, KY (US); Lance GATEWOOD, Louisville, KY (US); Anthony J. YOUNG, Louisville, KY (US); Kevin RANEY, Louisville, KY (US); Robert BROWDER, Louisville, KY (US); Marvin Gregory WHITLOCK, Louisville, KY (US); Scott CRANCE, Louisville, KY (US); Ken ICE, Louisville, KY (US); Michael KARAGLANIS, Louisville, KY (US); Brian YOUNT, Louisville, KY (US); Barry SWEATT, Louisville, KY (US); Thomas M. PHILLIPS, Louisville, KY (US); Logan YOUNG, Louisville, KY (US); Derek Robert STRUM, Louisville, KY (US); David Wesley CALDWELL, Louisville, KY (US); James Thomas HIND, Louisville, KY (US)

(73) Assignee: Aegis Sortation, LLC, Louisville, KY (US)

(21) Appl. No.: 19/248,072

(22) Filed: Jun. 24, 2025

Related U.S. Application Data
(63) Continuation-in-part of application No. 19/218,256, filed on May 24, 2025.
Application No. 19/218,256 is a continuation-in-part of application No. 18/419,410, filed on Jan. 22, 2024.
Application No. 18/419,410 is a continuation-in-part of application No. 18/399,000, filed on Dec. 28, 2023, now Pat. No. 12,312,180.
Application No. 18/399,000 is a continuation of application No. 18/092,226, filed on Dec. 31, 2022, now Pat. No. 12,012,290.
Application No. 18/092,226 is a continuation-in-part of application No. 17/843,313, filed on Jun. 17, 2022, now Pat. No. 11,969,759.
Application No. 17/843,313 is a continuation of application No. 17/566,527, filed on Dec. 30, 2021, now Pat. No. 11,731,169.
(60) Provisional application No. 63/216,340, filed on Jun. 29, 2021.
(60) Provisional application No. 63/440,439, filed on Jan. 22, 2023.
(60) Provisional application No. 63/456,088, filed on Mar. 31, 2023.
(60) Provisional application No. 63/539,884, filed on Sep. 22, 2023.
(60) Provisional application No. 63/543,450, filed on Oct. 10, 2023.
(60) Provisional application No. 63/651,989, filed on May 25, 2024.
(60) Provisional application No. 63/663,667, filed on Jun. 24, 2024.

(51) Int. Cl. B65G 47/19; B65G 47/26; B65G 47/48

(52) U.S. Cl. CPC B65G 47/19; B65G 47/268; B65G 47/48; B65G 2201/0285; B65G 2203/0241; B65G 2203/044

(57) ABSTRACT

A container exchange method is provided including monitoring a status of containers disposed in a parcel transfer area and automatically controlling an automated mobile exchange device, holding an empty container, to approach a position of a first container, of the plurality of the containers, based on the status of the first container. The automated mobile exchange device may be controlled based on a fill level of the first container. The automated mobile exchange device may then us the empty container to push the first container from the parcel transfer area to a transfer mechanism, whereby the first container is transferred to a takeaway conveyor, and the empty container is moved into the parcel transfer area.

### CROSS-REFERENCE TO RELATED APPLICATIONS

This present Application claims the benefit of U.S. Provisional Application 63/663,667 filed Jun. 24, 2024, and PCT Application No. PCT/US2024/012440, filed Jan. 22, 2024, and is a Continuation-in-part of U.S. application Ser. No. 19/218,256 filed May 24, 2025.

U.S. application Ser. No. 19/218,256 claims the benefit of U.S. Provisional Application 63/651,989, filed May 25, 2024.

U.S. application Ser. No. 19/218,256 is a Continuation-in-part of U.S. application Ser. No. 18/419,140 filed Jan. 22, 2024, which is a Continuation-in-part of U.S. application Ser. No. 18/399,000 filed Dec. 28, 2023, which is a continuation of U.S. application Ser. No. 18/092,226 filed Dec. 31, 2022, which is a Continuation-in-part of U.S. application Ser. No. 17/843,313 filed Jun. 17, 2022, which is a continuation of U.S. application Ser. No. 17/566,527 filed Dec. 30, 2021, which claims the benefit of U.S. Provisional Application 63/216,340, filed Jun. 29, 2021 in the United States Patent Office.

The disclosures of all of the above-identified Applications, including all attachments thereto, are incorporated herein by reference in their entireties.

### BACKGROUND

### 1. Field

Apparatuses and methods consistent with example embodiments relate to automated sortation systems and methods, and more particularly to automated container exchange systems and methods

### 2. Description of Related Art

Related art automated sortation systems any methods may utilize containers which are filled with items, used to transport items among stations and are then emptied. A process and/or system of exchanging a full container with an empty container can comprise a multi-step process may be time consuming.

### SUMMARY OF EXAMPLE EMBODIMENTS

Example embodiments may address at least the above problems and/or disadvantages and other disadvantages not described above. Also, example embodiments are not required to overcome the disadvantages described above, and may not overcome any of the problems described above.

According to an aspect of an example embodiment, a container exchange system comprises: a sorter divert mechanism configured to direct parcels into one of a plurality of containers disposed in a parcel transfer area; a takeaway conveyor configured to transport any container disposed thereon away from the parcel transfer area; a transfer mechanism positioned between the parcel transfer area and the takeaway conveyor and configured to direct any container disposed thereon onto the takeaway conveyor; at least one sensor configured to sense a fill status of the plurality of containers disposed in the parcel transfer area; an automated mobile exchange device configured to releasably attach to an empty container and controllable to use the empty container to push a container from the parcel transfer area onto the transfer mechanism.

According to an example implementation, the at least one sensor may comprise a sensor configured to determine a fill status of each of the plurality of containers disposed in the parcel transfer area.

According to an example implementation, the automated mobile exchange device may be one of an automated mobile robot and an automated guided vehicle.

According to an example implementation, the transfer mechanism may be one of a roller array and a slide.

According to an example implementation, the transfer mechanism may be angled downward from a first end adjacent to the parcel transfer area to a second end adjacent to the takeaway conveyor.

According to an aspect of an example embodiment, an automated container exchange system may comprise: at least one sensor configured to sense a status of each of the plurality of containers disposed in a parcel transfer area; an automated mobile exchange device; a transfer mechanism; a takeaway conveyor; a controller comprising a non-volatile memory storing instructions thereon, and a processor configured to execute the instructions, wherein the controller is communicatively connected to the at least one sensor and the automated mobile exchange device and is configured to execute the instructions to thereby: monitor a status of each of the plurality of containers disposed in the parcel transfer area via the at least one sensor, control the automated mobile exchange device, holding an empty container, to approach a position of a first container, of the plurality of containers, based on the status of the first container reaching a fill threshold; controlling the automated mobile exchange device to push the first container, with the empty container, from the parcel transfer area into a transfer mechanism, thereby positioning the empty container into the parcel transfer area.

According to an example implementation, the automated mobile exchange device may be one of an automated mobile robot and an automated guided vehicle.

According to an example implementation, the transfer mechanism may comprise one of a roller array and a slide.

According to an example implementation, the transfer mechanism may be angled downward from a first end adjacent to the parcel transfer area to a second end adjacent to the takeaway conveyor.

According to an example implementation, the processor may be further configured to control the automated mobile exchange device to disengage from the empty container.

According to an example aspect of an example embodiment, a container exchange method comprises: monitoring a status of each of a plurality of containers disposed in a parcel transfer area; automatically controlling an automated mobile exchange device, holding an empty container, to approach a position of a first container, of the plurality of containers, based on the status of the first container reaching a fill threshold; automatically controlling the automated mobile exchange device to push the first container, with the empty container, from the parcel transfer area onto a transfer mechanism, thereby positioning the empty container into the parcel transfer area; and diverting the first container onto a takeaway conveyor using the transfer mechanism.

According to an example implementation, the monitoring comprises utilizing at least one sensor to determine a fill status of each of the plurality of containers disposed in the parcel transfer area.

According to an example implementation, the automated mobile exchange device is one of an automated mobile robot and an automated guided vehicle.

According to an example implementation, the transfer mechanism comprises one of a roller array and a slide.

According to an example implementation, the transfer mechanism is angled downward from a first end adjacent to the parcel transfer area to a second end adjacent to the takeaway conveyor.

According to an example implementation, the method may further comprise disengaging the automated mobile exchange device from the empty container.

### BRIEF DESCRIPTION OF THE DRAWINGS

The above and/or other implementations will become apparent and more readily appreciated from the following description of example embodiments, taken in conjunction with the accompanying drawings, in which:

FIGS. 1A-1C are different perspective views of a smart bin according to one or more example embodiments;

FIG. 1D is a plan view of the front of a smart bin according to one or more example embodiments;

FIG. 1E is a plan view of a side of the smart bin according to one or more example embodiments;

FIGS. 2A-2F show different views of an example smart bin according to one or more example embodiments;

FIGS. 3A-3C are, respectively, an isometric view, a top view and a side view of a smart bin according to one or more example embodiments;

FIG. 4 diagrammatically illustrates an example of a system configuration including containers;

FIG. 5 is a block diagram illustrating example of certain features of a system and devices according to one or more example embodiments;

FIG. 6 diagrammatically illustrates an example of an automated hitching system, according to one or more example embodiments;

FIGS. 7A and 7B diagrammatically illustrate an example of features and operation of devices, and associated methodology, according to one or more example embodiments;

FIGS. 8A-8D diagrammatically illustrate in partial enlarged views examples of features and operation of a system, and associated methodology, according to one or more example embodiments;

FIGS. 9A-9G diagrammatically illustrate examples of features and operation of system and devices, and associated process flow, according to one or more example embodiments;

FIGS. 10A-10H illustrate a container exchange system according to one or more example embodiments;

FIGS. 11A and 11B diagrammatically illustrate a system and components of an example implementation of an elevated debag concept according to example embodiments; and

FIGS. 12A and 12B diagrammatically illustrate a system and components of an example implementation of a floor level debag concept according to example embodiments.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Expressions of relational orientation, such as “upper,” “lower,” “inside,” “outside,” etc. which are used for explaining the structural positions of various components as described herein, are not absolute but relative. The orientation expressions are appropriate when the various components are arranged as shown in the figures, but should change accordingly when the positions of the various components in the figures change.

Expressions of relational orientation, such as “upper,” “lower,” “inside,” “outside,” etc. which are used for explaining the structural positions of various components as described herein, are not absolute but relative. The orientation expressions are appropriate when the various components are arranged as shown in the figures, but should change accordingly when the positions of the various components in the figures change.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described herein in detail.

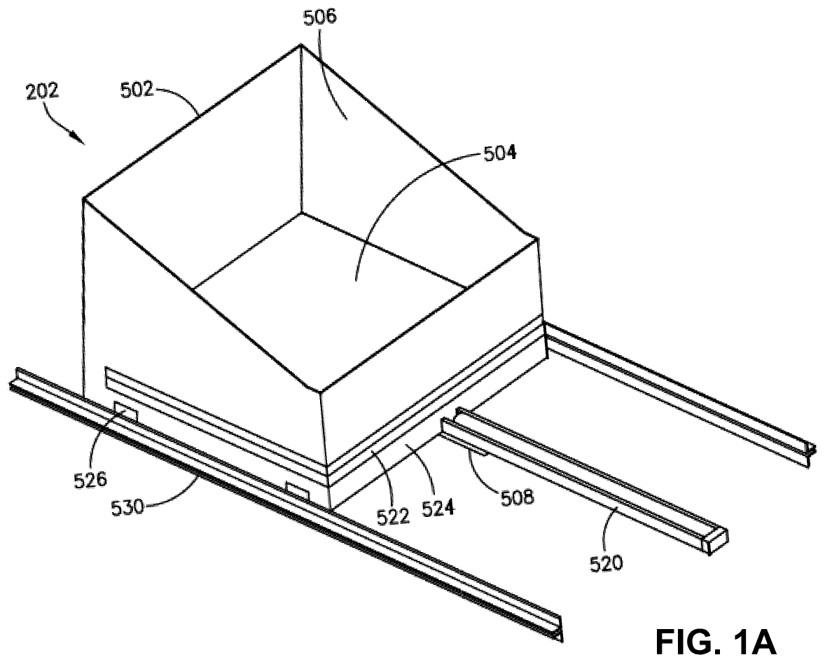

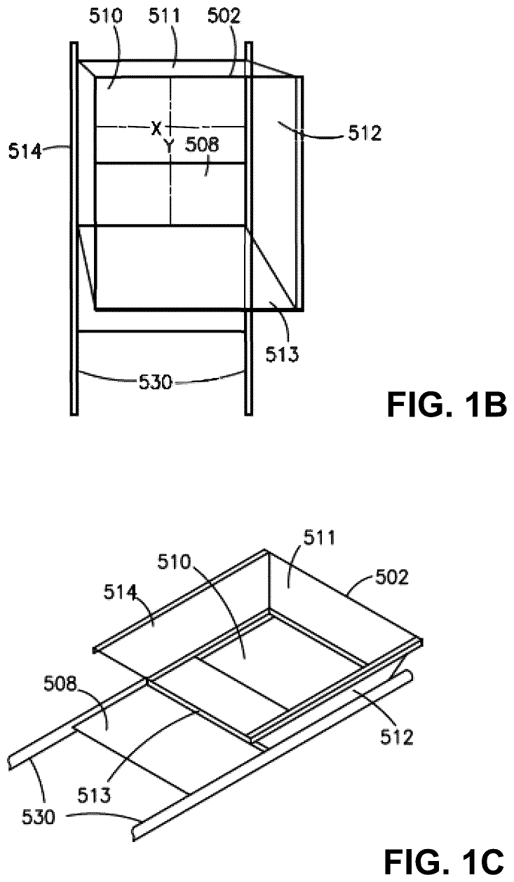

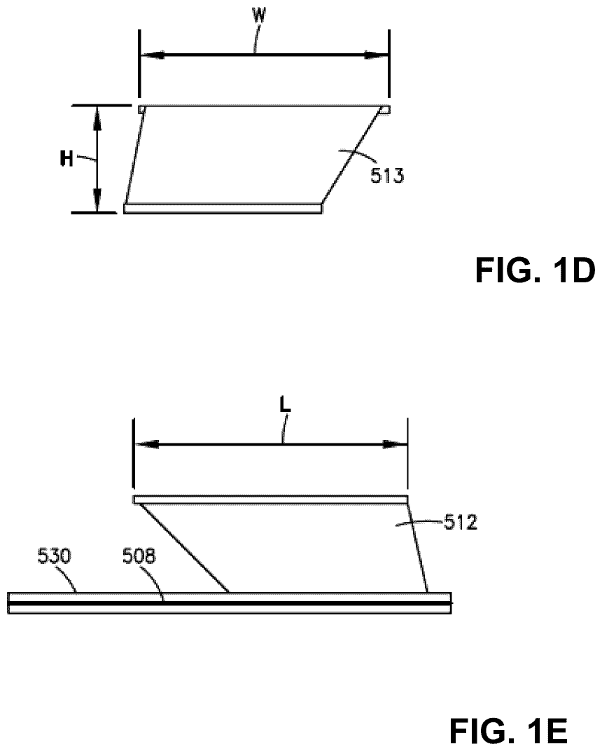

FIGS. 1A-1E illustrate a smart bin 202, according to an example embodiment: FIGS. 1A, 1B, and 1C are different perspective views of the smart bin; FIG. 1D is a plan view of the front of the smart bin; and FIG. 1E is a plan view of a side of the smart bin. As shown in FIGS. 1A-1E, the smart bin 202 includes a bottom 504, and a side wall 502 extending upward from each edge of the bottom 504, such that the bottom 504 and side walls 502 together define a cavity 506, therewithin. The cavity 506 can have any of a variety of dimensions, including cross-section X-Y, height H, width W, and length L, sufficient to accommodate a plurality of packages therewithin that can be received from or transferred or released to a conveyor of a sortation conveyor system. The bottom 504 comprises a gate 508, which is moveable, for example slidable, between an open position and a closed position. When the gate 508 is in the open position, a passage 510 is defined by lower edges of the side wall 502, and a rear edge of the bottom 504/gate 508, as shown in FIGS. 1B and 1C. The passage 510, thus open, enables packages to be released from the cavity 506, for example onto a conveyor. The side walls 502 may comprise four adjoining sections 511, 512, 513, and 514, which together to define sides of the cavity 504 having an essentially rectangular bottom with a cross-section X-Y. One or more of the sections 511, 512, 513, and 514 may slant outward from their respective bottom edges, such that one or more of the sections 511, 512, 513, and 514 may have a rectangular shape or a trapezoidal shape. The cavity 504 may have a height H, a width W, and a length L, as shown in FIGS. 1D and 1E. The gate 508 can be a slide gate having a linear guide system 530 and a linear actuator 520. The guide system 530 may include two or more guide rails, as shown in FIGS. 1A, 1B, 1C, and 1E. Further components may be included in the smart bin 202, such as a strip bush holder 522, a strip bush 524, and a pillow block 526, which may facilitate operation of the smart bin 202.

According to example implementations, Ultra High Molecular Weight Polyethylene (UHMW), or other types of low-friction material, can be used for manufacturing and/or for lining any one or more components of the smart bin 202.

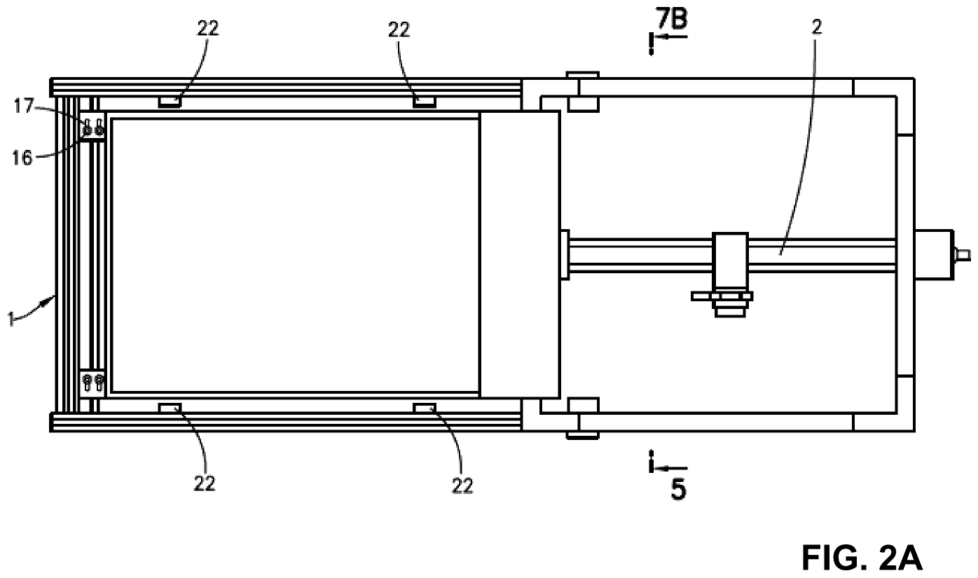

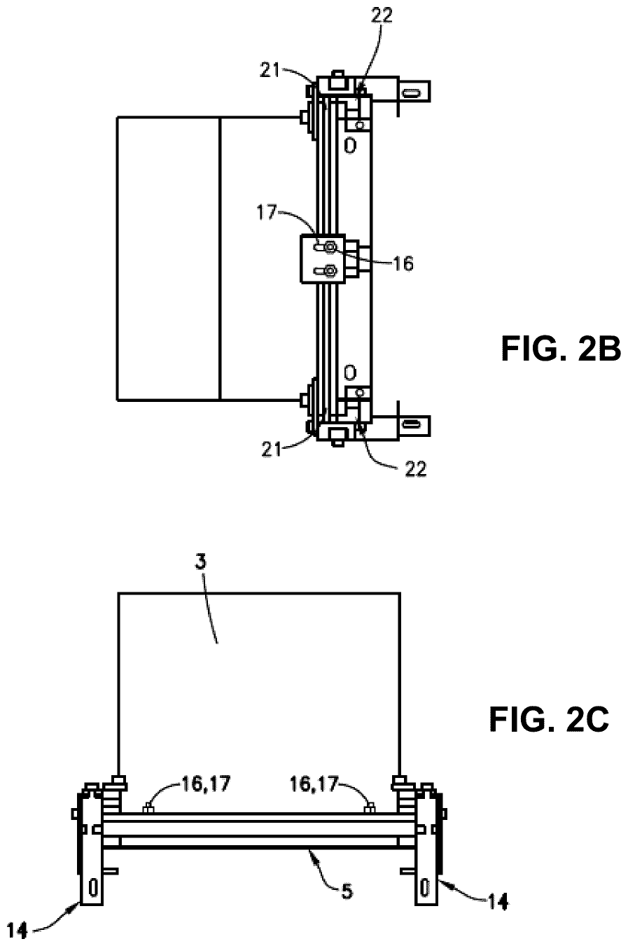

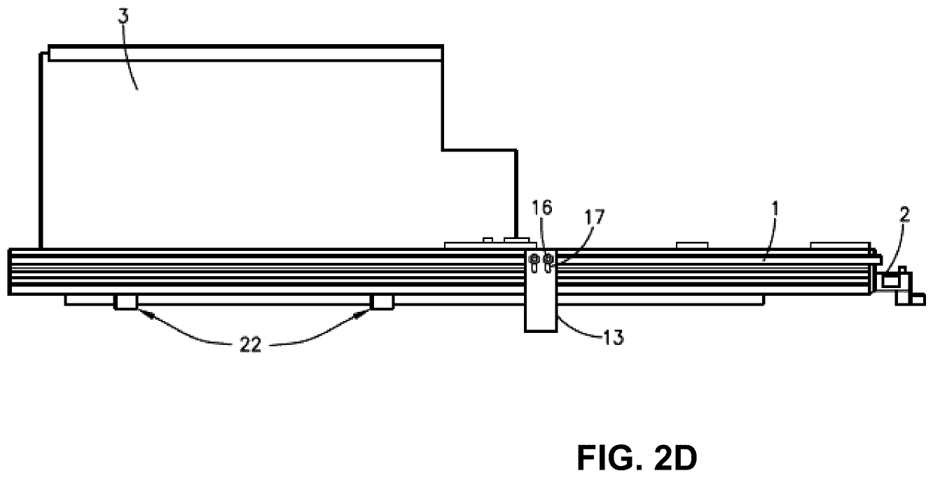

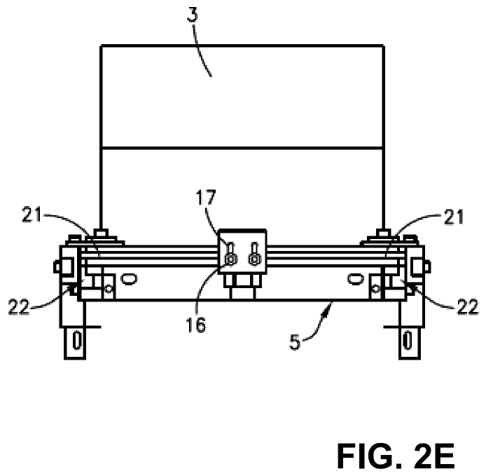

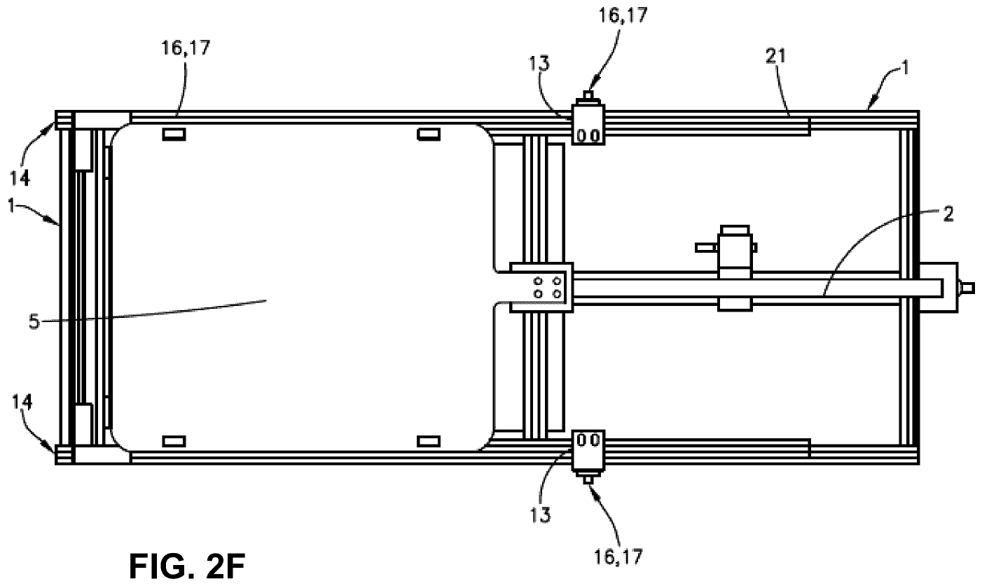

FIGS. 2A-2F illustrate another example smart bin according to an example implementation in which: 1 is a frame assembly; 2 is a cylinder assembly; 3 is a smart bin assembly; 4 is a frame connector plate; 5 is a slide gate; 6 is a smart bin-right; 7 is a smart bin-left; 8 is a smart bin-sorter side; 9 is a smart bin-operator side; 10 is a smart bin-belt retainer plate; 11 is a smart bin-belt wiper; 12 is a smart bin-belt return plate with weldnuts; 13 is a slide gate mounting angle; 14 is a slide gate end mount plate; 15 is a smart bin-UIHMW wiper; 16 is a t-bolts for extrusion slots; 17 is a t-bolt lock nuts for extrusion slots; 18 is a side rails extrusion x 69.5 long (1×3 slots); 19 is an intermediate strut extrusion×25.375 long (1×1 slots); 20 is an intermediate struts extrusion×25.375 long (1×3 slots); 21 is a bearing rail igus size 16 rail×1346 mm long; and 22 is a bearing igus drilling with bearings size 16.

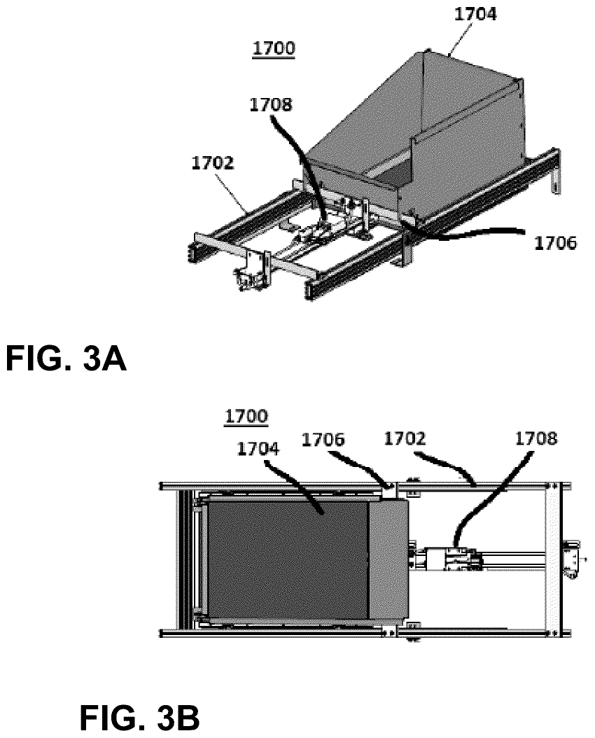

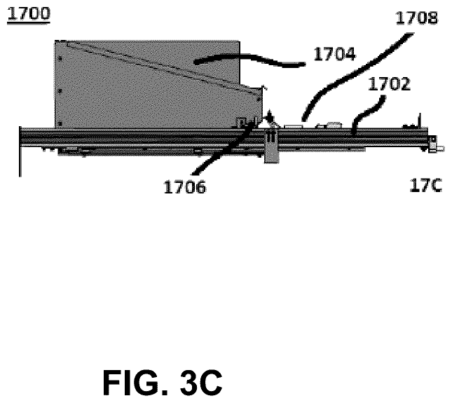

FIGS. 3A-3C illustrate in an isometric view, top view and side view, respectively, another example embodiment of a smart bin 1700.

In an example implementation, smart bin 1700 can have at least the functionality similar to that of a smart bin 202 described with reference to FIGS. 1A-1E above. According to further example implementations, smart bin 1700 can comprise hold-down tabs 1706 on the front of bin body 1704, so that package weight does not shift the bin for example with respect to frame assembly 1702. According to yet further example implementations, smart bin 1700 can comprise proximity flags and one or more sensor added to for example slide cylinder 1708 for a more accurate readings when the gate is opened or closed.

In a further example implementation, the VPU logical component can make specific determinations based upon statistical probabilities to communicate the appropriate actions to electro-mechanical device(s). These logical decision algorithms can be at least in part the guidelines directing various subordinate controllers and devices with regards to container closing or zipping. VPU and any other logical component or other components may also utilize artificial intelligence and machine learning to enhance performance over time.

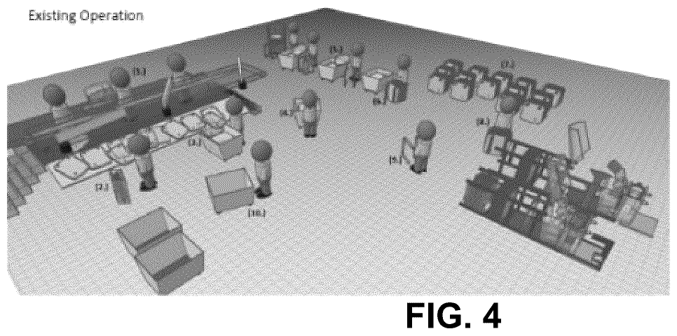

Referring to FIG. 4, containerization for materials, products, packages, and other items in a sortation conveyor system requires containers such as, for example, any one or more of the example smart bins described hereinabove with respect to FIGS. 1A-1E, 2A-2F, and 3A-3C. These containers can create numerous logistic issues and additional costs for industries. Containers must be acquired, stored, transported to the containerization process, and transported again to its intermediate or destination. This process can be labor intensive and costly to the industry. In addition, container logistic bottle necks may be created negatively affecting the containerization process itself. An automated consolidated bagging (ACB) system may require over a thousand containers per hour for each installed system

In an example of manual processes as shown in FIG. 4, containers housing product are emptied in one location (1), then the containers themselves are containerized by placing them inside one another or stacking them in small groups or piles (2). The containerized containers are then placed into yet another container for transportation such as a cart, gaylord or gurney (3). The containerized containers of containers are then manually transported to the ACB, automated consolidated bagging parcel containerization area (4). Next the containers are de-containerized (5) and staged for use on container processing racks, or bag stands, each holding approximately twenty-five containers (6). These racks are first staged nearby (7) and later manually transported to the appropriate SmartBagger position for use as required (8). Finally, the container processing racks (9) and the now empty containers for the containers, carts, gaylords or gurneys (10) need to be manually repositioned back to the starting point where the process is repeated throughout the operation.

Methods and apparatuses to improve on any one or more of these repetitive, laborious, costly, and ergonomically challenged processes is greatly desired. Mobile devices or robots, whether autonomous or guided, are well suited to assist in this task. Mobile robots may contribute to a reduction in the manual processes of transportation. In addition, the use of these robots may contribute to the reduction of other elements in the containerization logistic process.

Example implementations can provide a system that may incorporate, but are not limited to one or more of autonomous or guided mobile robots or vehicles, AMR(s) or automated guided vehicles, AGV(s), and a vision system or sensors to monitor the mobile robot positioning and docking.

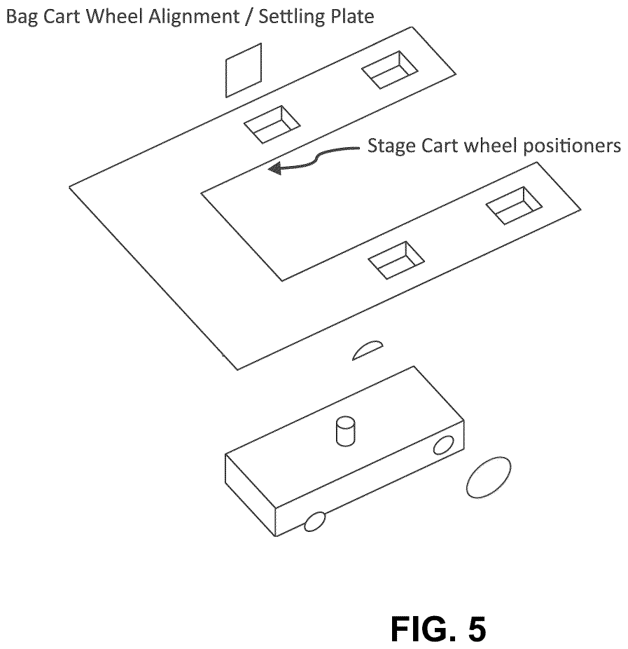

In yet another exemplary implementation, as diagrammatically shown in FIG. 5, a Bag SmartCart Floor Wheel Aligner may be used so the AMR, can autonomously drive itself into the proper location for docking. The four wheels of the AMR or cart can settle into the depressions of the floor plate. This positioning could then be sensed by the AMR or external sensors.

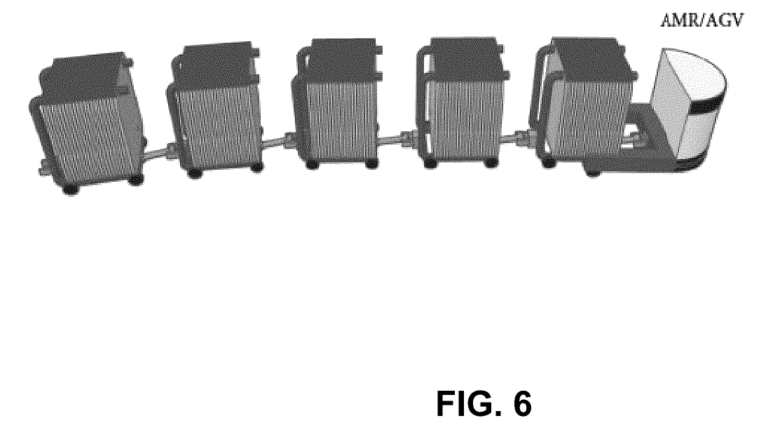

As further illustrated in the example of FIG. 6, the design of example implementations could incorporate an automated hitching system to support a train of Empty or Full SmartCarts to reduce the AMR/AGV quantity and subsequent cost of the system.

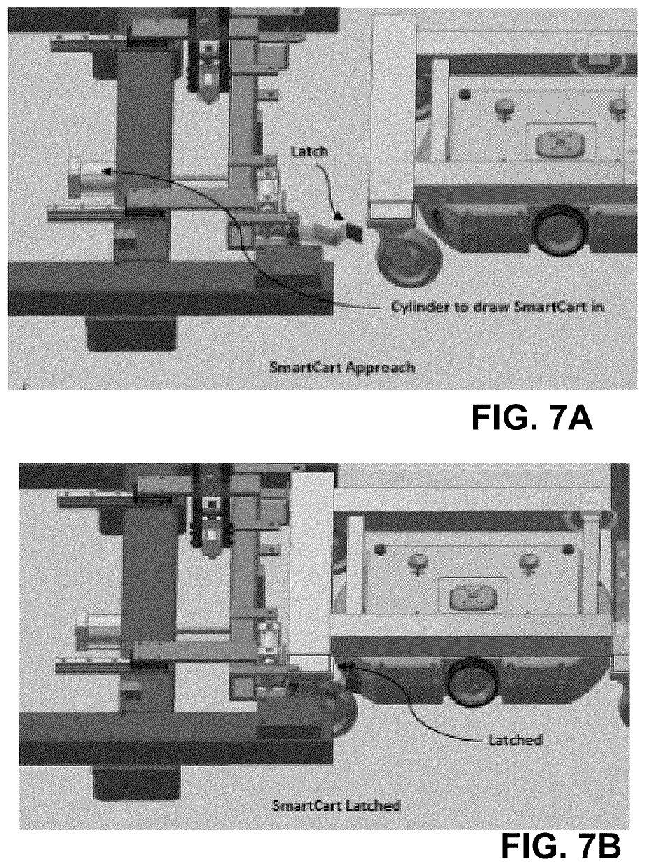

Referring to FIGS. 7A and 7B, a sequence of SmartCart latching operations and associated mechanical features provided according to example embodiments of the present disclosure can be applicable to any of the systems and operations described above.

One or more example embodiments may provide a system, components, and methodology for container transport and/or for container exchange within a sortation system.

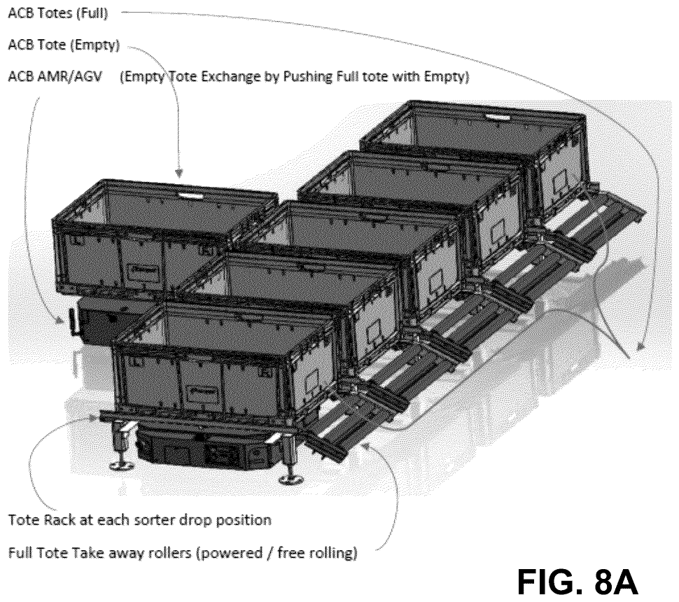

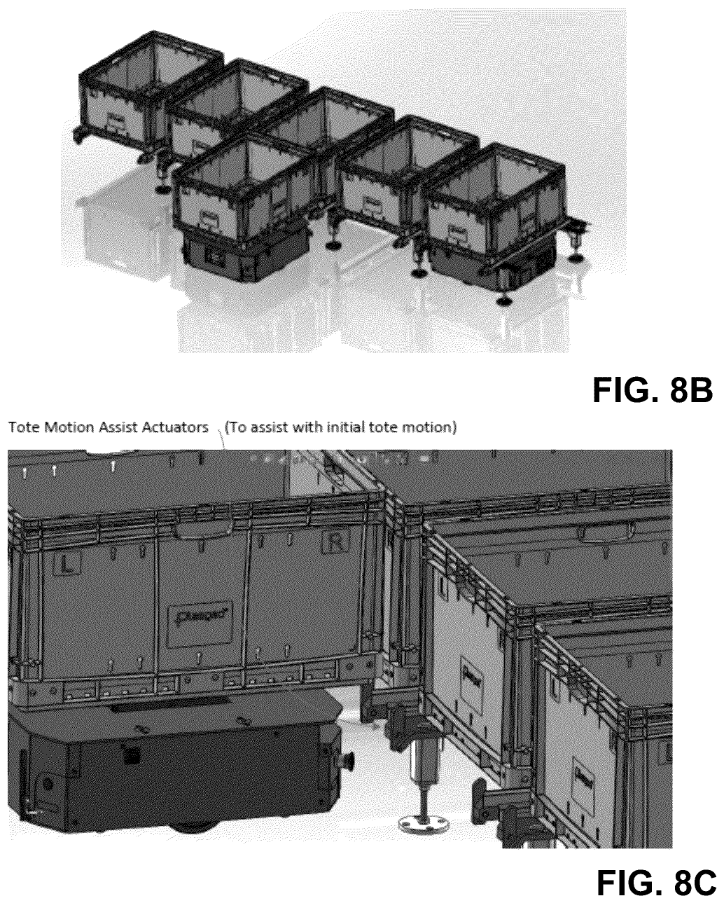

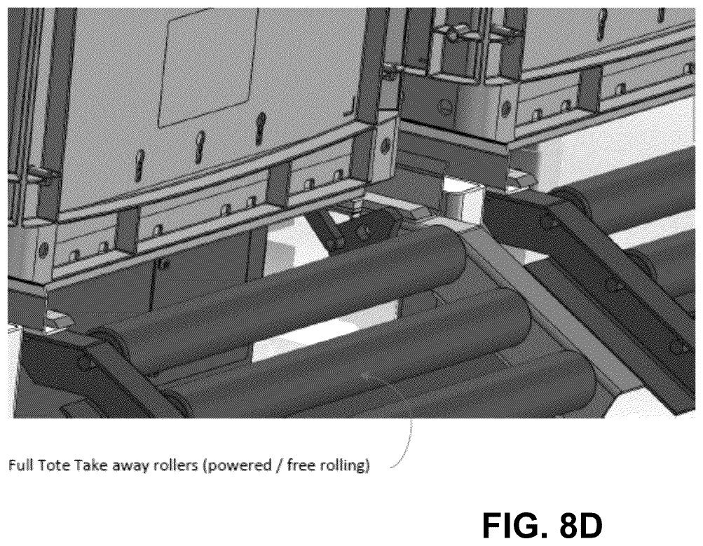

According to an example embodiment described with reference to FIGS. 8A-8D, a container (such as a tote) exchange can be facilitated by pushing a full tote with an empty tote (example.g. FIGS. 8A and 8D); a tote rack may be provided at a sorter drop position at which a tote is loaded (e.g. FIGS. 8A, 8B, and 8C); and take away rollers may be provided to facilitate the moving of totes (e. g. FIGS. 8A and 8D). In an example implementation, a motion assist actuator may be provided as illustrated in the non-limiting example of FIG. 8C to assist and/or facilitate an initial tote motion.

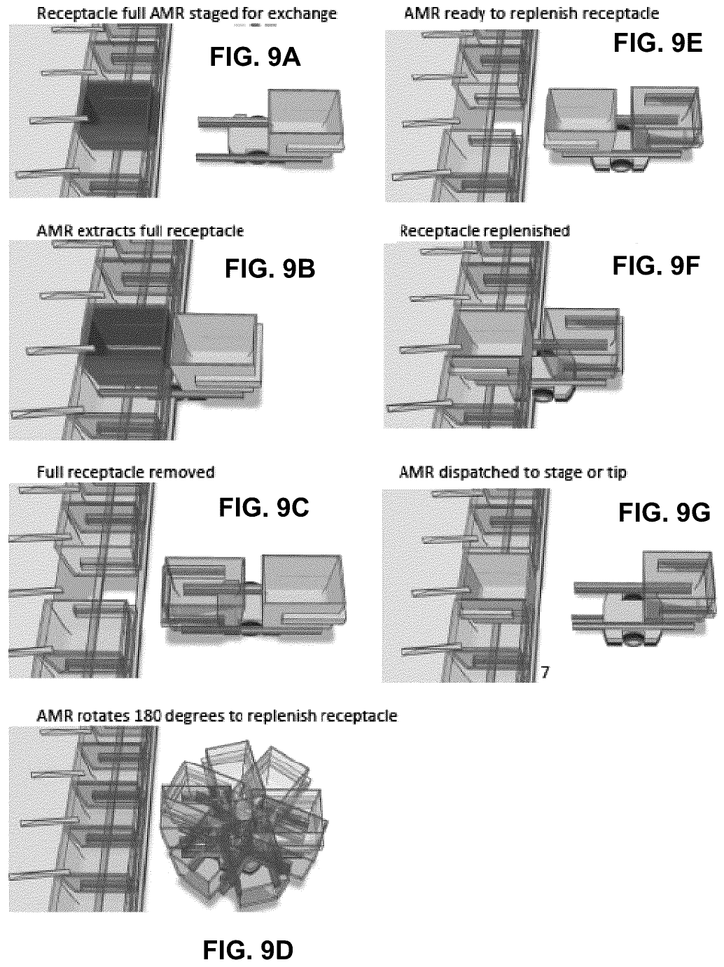

With example reference to FIGS. 9A-9G, one or more example embodiments may provide dual receptacle carts which are engineered to hold two containers (e.g. totes) in order to facilitate optimized receptacles replenishment to reduce sorter destination disabled time and recirculated or re-handled product. As shown in FIGS. 9A-9G, for example, a dual receptacle care exchange sequence, including certain process steps and associated mechanical configurations can comprise:
1. Receptacle full AMR staged for exchange
2. AMR extracts full receptacle
3. Full receptacle removed
4. AMR ready to replenish receptacle
5. MR rotates 180 degrees to replenish receptacle
6. Receptacle replenished
7. AMR dispatched to stage or tip

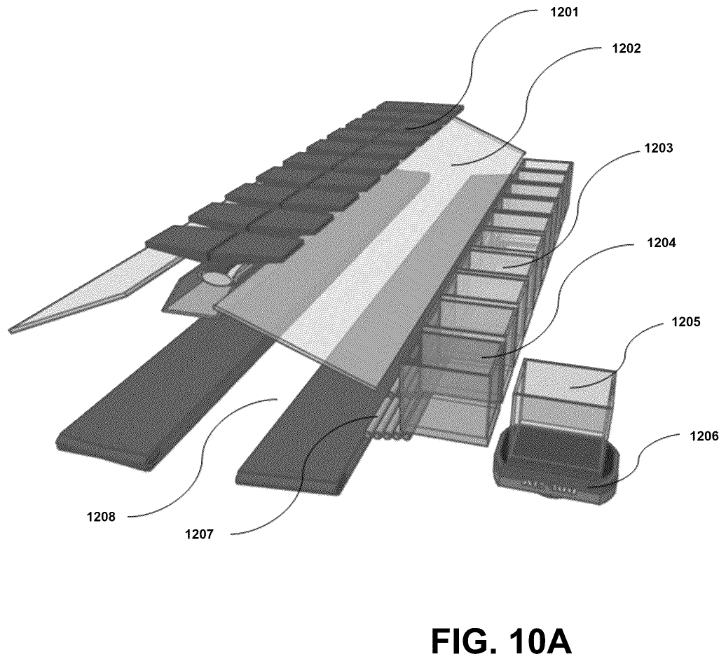

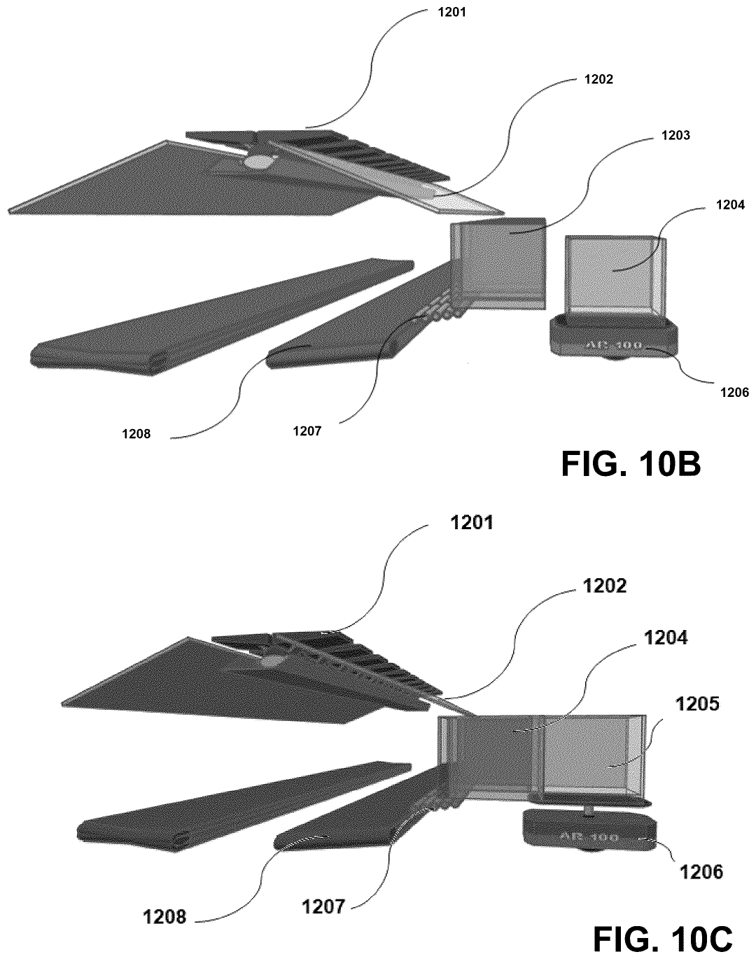

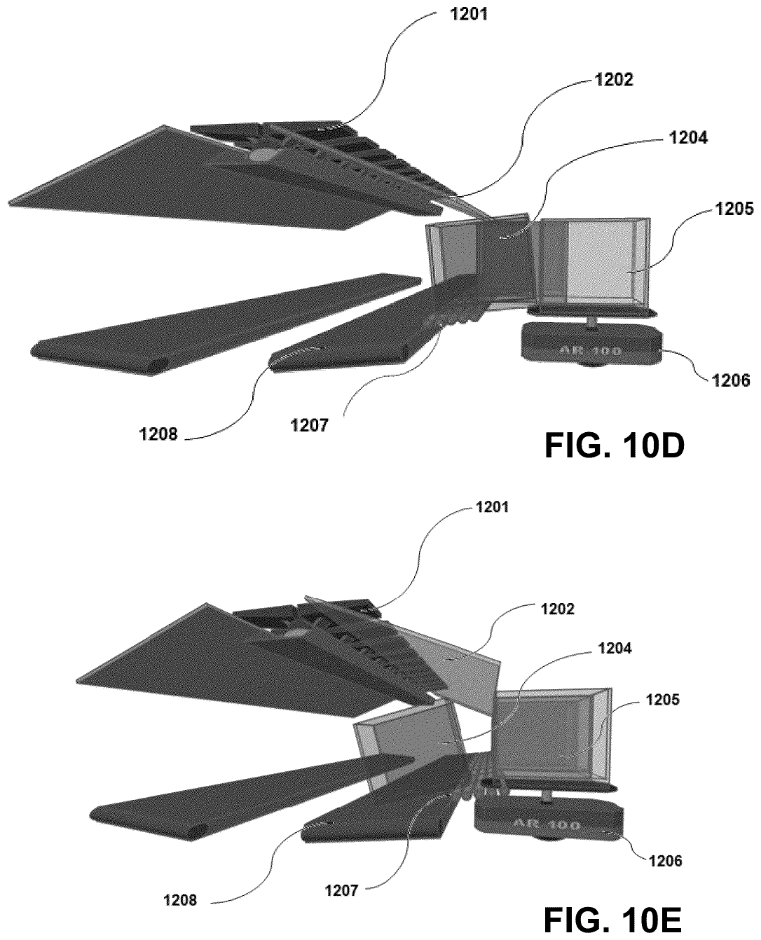

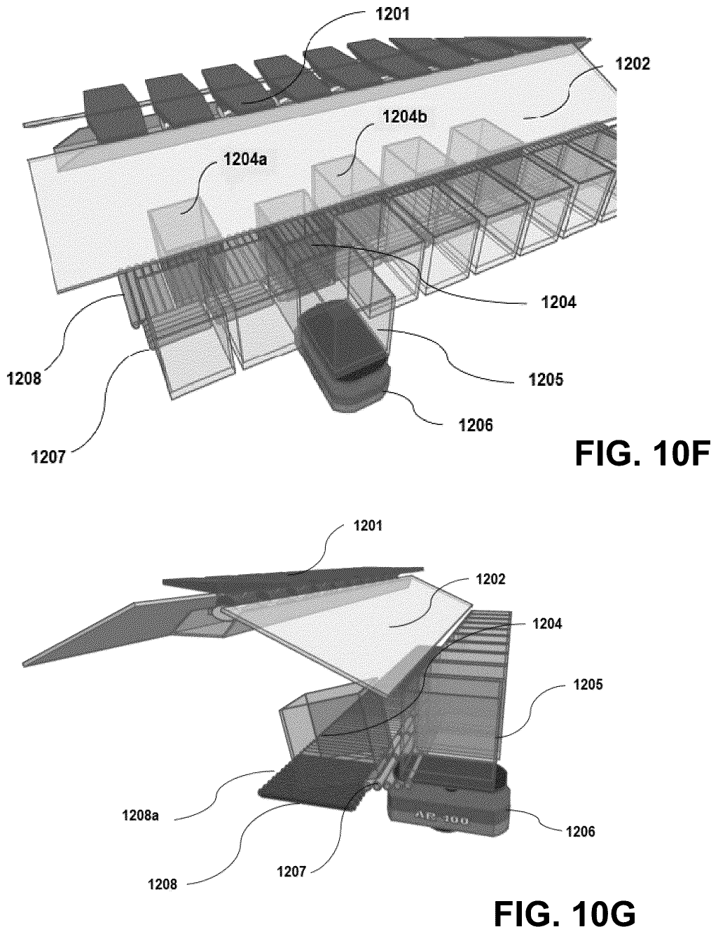

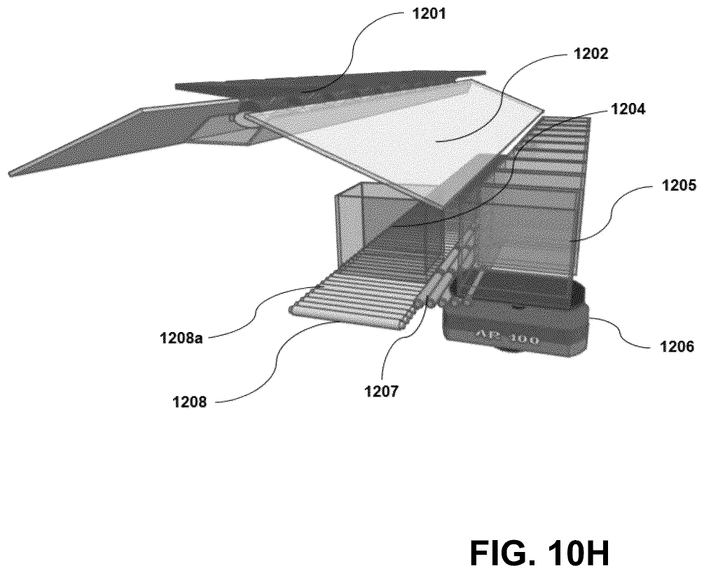

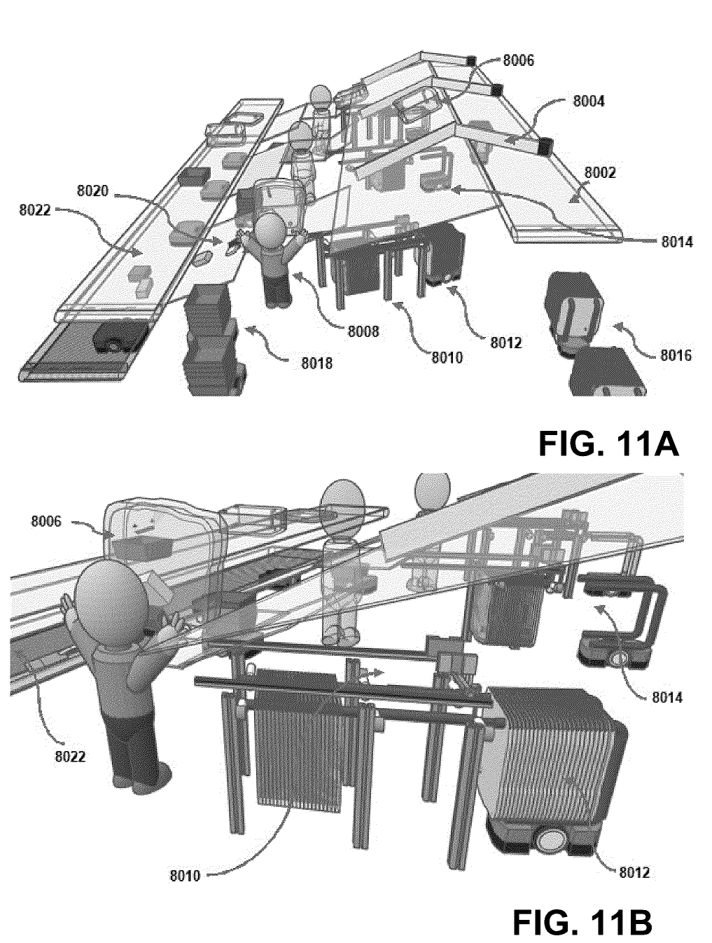

FIGS. 10A-10H illustrate another container exchange system according to one or more example embodiments.

One or more example embodiments may relate generally to systems and methods where objects, such as packages, are accumulated, stored, and/or transported in containers, and more particularly sortation systems and methodologies that divert loose small packages into container, which can then be transported.

One or more example embodiments may relate to systems and methods that provide automation for transporting of container to/from designated areas, and is applicable to any and all systems and methodologies disclosed in the above-referenced related applications.

One or more example embodiments may provide a system, components and methodology for container exchange process.

By way of an example, a process and/or system of exchanging a full container with an empty container can comprise a multi-step process which can be time consuming for Autonomous Mobile Robot(s) (AMRs) and/or Automated Guided Vehicle(s) (AGVs) units utilized in such a system or process. For example, an increased number of AMR/AGV units may be required for the exchanges, and increased travel pathway distances may be required, which may diminish battery life, increase unit count for recharging stations, and may create pathway congestion which may further decrease exchange rate and require a greater overall system footprint to accommodate the increased traffic flow.

For example, such a nine-step container exchange process may include: (1) an available, first AMR/AGV, without a container, travels to align itself with a full container; (2) a first AMR/AGV positions to engage with the full container; (3) a first AMR/AGV acquires the full container, which may include: utilizing a lift, utilizing a latching mechanism, and other means of securing the full container with first AMR/AGV for transporting the full container; (4) a first AMR/AGV removes the full container; (5) a first AMR/AGV travels to full container processing or staging area; (6) another, second AMR/AGV, with an empty container, positions itself to the position now void of a container, once the first AMR/AGV with the full container is clear and no longer an obstacle; (7) a second AMR/AGV deposits the empty container, which may include utilizing a lift, utilizing a latching mechanism, and other means of securing the empty container with first AMR/AGV for depositing the empty container; (8) a second AMR/AGV disengages the empty container; and (9) a second AMR/AGV travels to acquire another empty container from the empty container staging area.

One or more example embodiments may achieve increased performance, for example and without limitations for an ACB system utilizing for example container driven AMR(s) and/or AGV(s). According to an example implementation, systems and methodologies may be provided to facilitate higher exchange rate for tasks comprising systematic exchange of a full container(s) or tote(s) with empty container(s) or tote(s). According to an example implementation, a system can comprise one or more AMR(s) and/or AGV(s), one or more tote and/or container stand(s) and/or racking system(s), one or more gravity and/or powered roller system(s), and one or more take away conveyor(s), where gravity and/or powered rollers could be utilized to optimize the system and/or the process and/or any portion thereof.

One or more example embodiments may provide a process and/or system of exchanging a full container with an empty container according to disclosed exemplary embodiments can comprise the following process steps together with associated hardware and/or software: (1) available AMR/AGV with an empty container travels to align itself with a full container, which is positioned in a filling area such as a stationary fill position; (2) AMR/AGV positions to engage with the full container; (3) AMR/AGV pushes the full container with the empty container out of the filling area for transport to full container processing or staging area, for example in one motion, such that the empty container takes the position in the filling area vacated by the full container; (4) AMR/AGV disengages the empty container, and (5) AMR/AGV travels to acquire another empty container from the empty container staging area.

According to one or more example embodiments, a re-engineered AMR/AGV container exchange system as described above, may, but is not required to, facilitate the following improvements: (1) AMR/AGV unit count reduction including a reduced travel path time and distances, an improved container exchange time, an improved battery life, and a reduced charging time and charging station count; (2) Improved Sorter—ACB system performance including a reduced product recirculation count, and a reduced product rejection count; and (3) Improved overall system cost.

Referring to FIG. 10A, one or more example embodiments may provide a system comprising: a sorter divert mechanism 1201, where products/parcels can be selectively transferred to any of containers, such as a container 1203 or a container 1204 positioned in a product/parcel transfer area with respect to mechanism 1201, via for example and without limitation via a slide 1202; a detection mechanism for determining when an empty or a not-full container, such as container 1203 is sufficiently filled to become a full container, such as container 1204; an AMR/AGV exchange vehicle 1206 configured to transport an empty container; a full containers transfer mechanism 1207, which can comprise, for example gravity or powered rollers, to facilitate transfer of a full container 1203 out of the product/parcel transfer area for further processing, via for example a transfer to a full container processing lateral takeaway conveyor or powered rollers 1208.

For example in an ACB system, products or parcels can be selectively diverted by a sorter into available containers. Once the containers are full, a container exchange of a full container with an new empty container can be executed. It may be desirable for the exchange rate to be achieved quickly so that products or parcels are not left, for example in a sorter, without a container in which to divert. Such a void can create either re-handled items or rejected items, which can diminish the sorter and/or corresponding ACB system capacity and/or performance, which may negatively impact operating efficiencies and cost. One or more example embodiments may, but are not required to, address the desire for achieving an improved exchange rate by providing a high-speed container exchange system that may optimize the container exchange time and overall system performance, as further described for example and without limitation with reference to diagrammatic illustrations of FIGS. 10B-10H.

According to an example implementation, prior to the container being designated full, for example by ACB system hardware and/or software, an AMR/AGV unit 1206 can be dispatched with an empty container 1205 to be positioned/staged with respect to, for example directly in front of, the nearly full container 1204 to be exchanged, as shown, for example, in FIG. 10B.

According to an example implementation, once the system according to example embodiments determines the container is full or nearly full as desired, for example utilizing sensors, product/parcel count, volume metrics, or other methods, a system controller notifies a staged AMR/AGV unit 1206 transporting the empty container 1205 to initiate the exchange process. For example and without limitation, AMR/AGV unit 1206 can prepare for the exchange by utilizing lifting and or latching mechanism and traveling towards the full container 1204 to engage. In an exemplary implementation such an engagement can comprise direct container to container contact and/or a mechanical apparatus to facilitate the exchange process. For example, and without limitation, mechanical container latches, may be incorporated, as required, to ensure stability through the exchange process, where, for example, at an appropriate time the latches can be engaged and disengaged to facilitate movement of container 1204 and/or container 1205.

According to further exemplary implementations of disclosed embodiments, a full container 1204 can be staged, for example on a flat support or rack system, such that it may easily transfer from a stationary fill position onto the full container transport rollers 1207. For example, referring to non-limiting diagrammatic illustrations of FIGS. 10C and 10D, AMR/AGV unit 1206, can push a full container 1204 from such a stage (for example, a stationary flat support or rack system) onto the takeaway transport mechanism 1207.

In an example implementation, a takeaway transport mechanism 1207 can comprise for example and without limitation either powered or non-powered rollers, or a combination thereof, which rollers can be, but are not required to be for example in case of power rollers, designed with a declined angle to enable the full container 1204 to freely glide down the full container transport rollers 1207. In an example implementation, once the center of gravity of the full container 1204 has cleared the apex of the full container transport rollers 1207, the full container 1204 can tip so that the gravitational force can begin to act upon the full container 1204.

According to one or more example implementations, AMR/AGV unit 1206 can continue to push the full container 1204 as required until the empty container 1205 is in place at the stationary fill position, for example seated upon a flat support or rack system. The empty container 1205 positioning can be verified, for example by the AMR/AGV system, such that the ACB controls system can be notified that the exchange is complete, for example so that product/parcels sortation to this destination (for example, this stationary fill position) may be re-enabled. Essentially, at a same time, the full container 1204 may continue to travel for further processing, for example towards the full containers lateral take away conveyor and/or powered rollers 1208.

Referring to a non-limiting diagrammatic illustration of FIG. 10F, according to an example implementation, the full container lateral takeaway conveyor and/or powered rollers 1208 can be controlled by the ACB system such that during the exchange process there is a window available for full containers 1204 to transition between a full container 1204a and another full container 1204b. The ACB controller can track each of the full containers for this purpose and can also pre-empt the container exchange process, thus reducing exchange time due to this available window constraint. This can be accomplished for example by starting or stopping the full container lateral takeaway conveyor and/or powered rollers 1208 in sections or its entirety.

Referring to non-limiting diagrammatic illustrations of FIGS. 10G and 10H, in an example implementation, powered rollers can be utilized for the full container lateral takeaway system 1208, and the ACB controller, for example in coordination with the AMR/AGV system, may engage and/or disengage sections of rollers of system 1208, for example directly in front of a full container 1204 pathway to assist with the transfer of the full containers 1204 on to the lateral takeaway system 1208. For example, roller section, or destination zone, 1208a can be stopped until the container 1204 is fully loaded onto the full container lateral takeaway system 1208, while other roller sections or zones are operating, for example according to the overall system tote metering and/or induction requirements. Once the full container 1204 is fully transferred onto the full container lateral takeaway system 1208, the corresponding roller section 1208a may be restarted for transport. Container guides may be incorporated to ensure full container 1204 positioning so there is no container transport interference with equipment or other containers.

According to an example implementation, for example to enhance the full container tracking process, unique indicia can be placed on the containers or RFID tags affixed or embedded in the containers for use by the ACB controller. Such an implementation, for example in conjunction with the AMR/AGV system and subsystems, such as for example the SmartBagger, can be beneficial to facilitate system performance and, for example SmartBagger, labeling accuracy.

According to still further example implementations, an artificial intelligence system can be deployed, for example to augment, and/or work in conjunction with, the ACB controls system, for example to optimize the full container exchange sequencing to reduce exchange wait time, for example due to full container lateral takeaway system 8 window availability and/or AMR/AGV availability.

Referring to FIGS. 11A and 11B, according to another exemplary implementation of example automated debag system, an elevated debag area configuration may be utilized for processing bag, such as containerized smalls (bags) 8006, where such a configuration may comprise the following non-limiting components and/or stations:
Containerized and loose small packages feed conveyor 8002
Automated diverter to human debag work station 8004
Debag de-containerizing human position (3 depicted stations) 8008
Empty bag manual loading—SmartKart docking—empty bag offloading apparatus 8010
Fully loaded SmartKart/SmartBagger docking 8012
Empty SmartKart undocking 8014
Fully loaded SmartKart 8016
Empty tote mobile robot (return to unload area) 8018
Manual take away slide for de-containerized smalls 8020
De-containerized smalls conveyor (transport to sorter induction area) 8022

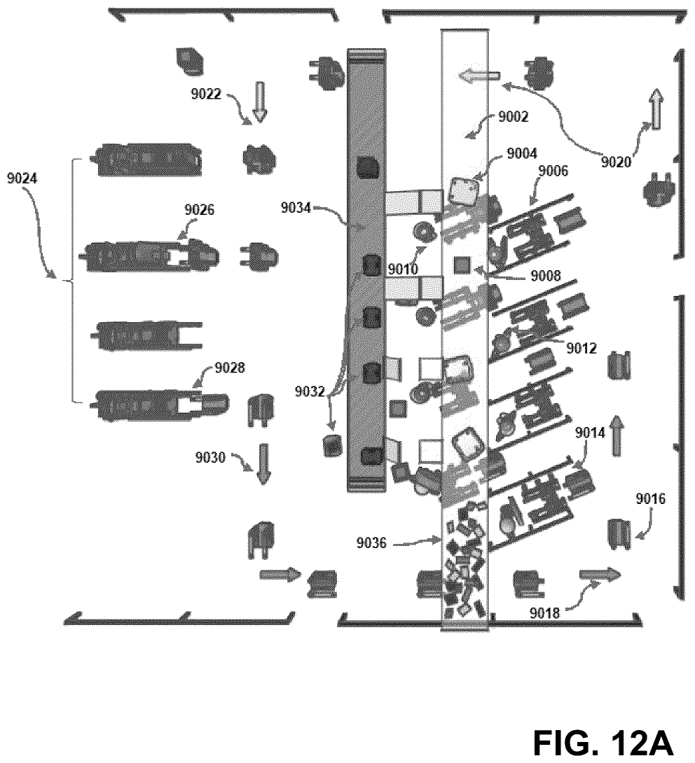

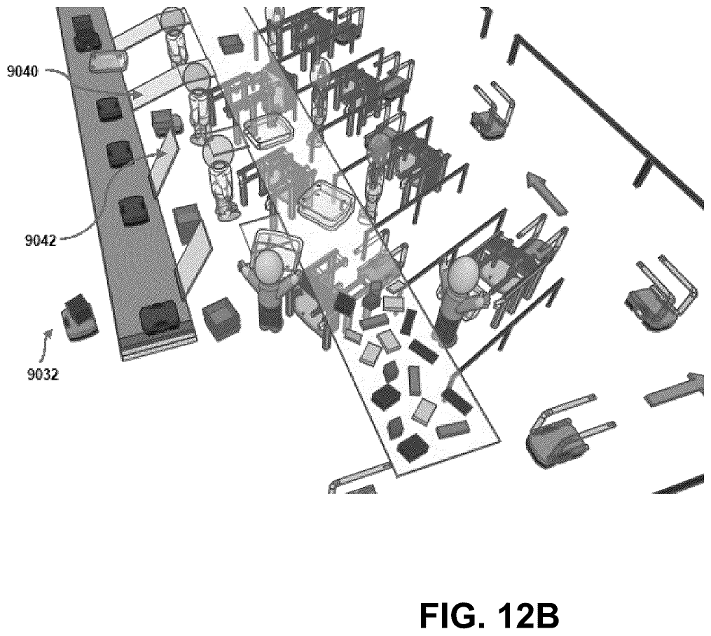

Referring to FIGS. 12A and 12B, according to another exemplary implementation of example automated debag system, a floor level debag area configuration may be utilized for processing bag, such as containerized smalls (bags) 9004. For example, and without limitation, in such a configuration both sides of the loose small packages feed conveyor 9002 may be staffed to optimize facility space. In an exemplary implementation, such a configuration can facilitate eliminating s requirement for the tusks to facilitate vertical movement of the empty bags. In an exemplary implementation of a SmartKart docking, empty bag offloading apparatus 9006 can be aligned on a single side of the loose small packages feed conveyor 9002 such that the mobile robot pathways may be minimized, which may also facilitating optimization of facility space. An exemplary configuration can facilitate implementation of a mobile robot loop concept for full and empty SmartKart(s), for example providing an empty SmartKart(s) mobile robot pathway 9018 and a fully loaded SmartKart mobile robot pathway 9022 as illustrated in the example of FIG. 12A. As further illustrated in the example of FIGS. 12A and 12B, a floor level debag area configuration may comprise the following non-limiting components and/or stations:
Containerized and loose small packages feed conveyor 9002
Empty bag manual loading—SmartKart docking—empty bag offloading apparatus 9006
Containerized smalls (tote) 9008
Left side de-containerizing human position (4 stations depicted) 9010
Right side de-containerizing human position (4 stations depicted) 9012
SmartKart docking position (8 depicted) 9014
Empty SmartKart(s) 9016
Fully loaded SmartKart 9020
SmartBagger(s) 9024
Fully loaded SmartKart/SmartBagger docking 9026
Empty SmartKart undocking 9028
Empty SmartKart(s) mobile robot pathway 9030
Empty tote mobile robot (for example, transporting empty totes back to unload area) 9032
Exception package conveyor (oversize, overweight, damaged, et cetera) 9034
De-containerized smalls conveyor (transport to sorter induction area) 9036

In yet further exemplary implementation, an exception package slide conveyor 9004, which may be configured with respect to containerized and loose small packages feed conveyor 9002 and exception package conveyor 9034, comprises a liftable configuration. For example, and without limitations a slide portion 9042 of conveyor 9004 can be lifted, for example to facilitate human walkway/egress.

While example implementations have been shown and described with reference to certain example embodiments, it will be understood by those skilled in the art that various changes in form and details may be made therein. For example, any of various communication protocols can be deployed in combination with any of various electronic sensors, and/or any of various visual and/or audio user interfaces can be implemented to facilitate processing and/or displaying information and/or controlling hardware and/or software components of example systems.

It may be understood that the example embodiments described herein may be considered in a descriptive sense only and not for purposes of limitation. Descriptions of features or implementations within each example embodiment may be considered as available for other similar features or implementations in other example embodiments.

While example embodiments have been described with reference to the figures, it will be understood by those of ordinary skill in the art that various changes in form and details may be made therein without departing from the spirit and scope as defined by the following claims.

What is claimed is:

1. A container exchange system comprising:
a sorter divert mechanism configured to direct parcels into one of a plurality of containers disposed in a parcel transfer area;
a takeaway conveyor configured to transport any container disposed thereon away from the parcel transfer area;
a transfer mechanism positioned between the parcel transfer area and the takeaway conveyor and configured to direct any container disposed thereon onto the takeaway conveyor;
at least one sensor configured to sense a fill status of the plurality of containers disposed in the parcel transfer area;
an automated mobile exchange device configured to releasably attach to an empty container and controllable to use the empty container to push a container from the parcel transfer area onto the transfer mechanism.

2. The system according to claim 1, wherein the at least one sensor comprises a sensor configured to determine a fill status of each of the plurality of containers disposed in the parcel transfer area.

3. The system according to claim 1, wherein the automated mobile exchange device is one of an automated mobile robot and an automated guided vehicle.

4. The system according to claim 1, wherein the transfer mechanism comprises one of a roller array and a slide.

5. The system according to claim 4, wherein the transfer mechanism is angled downward from a first end adjacent to the parcel transfer area to a second end adjacent to the takeaway conveyor.

6. An automated container exchange system comprising:
at least one sensor configured to sense a status of each of the plurality of containers disposed in a parcel transfer area an automated mobile exchange device;
a transfer mechanism;
a takeaway conveyor;
a controller comprising a non-volatile memory storing instructions thereon, and a processor configured to execute the instructions, wherein the controller is communicatively connected to the at least one sensor and the automated mobile exchange device and is configured to execute the instructions to thereby:
monitor a status of each of the plurality of containers disposed in the parcel transfer area via the at least one sensor,
control the automated mobile exchange device, holding an empty container, to approach a position of a first container, of the plurality of containers, based on the status of the first container reaching a fill threshold;
controlling the automated mobile exchange device to push the first container, with the empty container, from the parcel transfer area into a transfer mechanism, thereby positioning the empty container into the parcel transfer area.

7. The system according to claim 6, wherein the automated mobile exchange device is one of an automated mobile robot and an automated guided vehicle.

8. The system according to claim 6, wherein the transfer mechanism comprises one of a roller array and a slide.

9. The method according to claim 8, wherein the transfer mechanism is angled downward from a first end adjacent to the parcel transfer area to a second end adjacent to the takeaway conveyor.

10. The system according to claim 6, wherein the processor is further configured to control the automated mobile exchange device to disengage from the empty container.

11. A container exchange method comprising:
monitoring a status of each of a plurality of containers disposed in a parcel transfer area;
automatically controlling an automated mobile exchange device, holding an empty container, to approach a position of a first container, of the plurality of containers, based on the status of the first container reaching a fill threshold;
automatically controlling the automated mobile exchange device to push the first container, with the empty container, from the parcel transfer area onto a transfer mechanism, thereby positioning the empty container into the parcel transfer area; and
diverting the first container onto a takeaway conveyor using the transfer mechanism.

12. The method according to claim 11, wherein the monitoring comprises utilizing at least one sensor to determine a fill status of each of the plurality of containers disposed in the parcel transfer area.

13. The method according to claim 11, wherein the automated mobile exchange device is one of an automated mobile robot and an automated guided vehicle.

14. The method according to claim 11, wherein the transfer mechanism comprises one of a roller array and a slide.

15. The method according to claim 14, wherein the transfer mechanism is angled downward from a first end adjacent to the parcel transfer area to a second end adjacent to the takeaway conveyor.

16. The method according to claim 11, further comprising disengaging the automated mobile exchange device from the empty container.
